(19) United States
(12) Patent Application Publication
(10) Pub. No.: US 2024/0352239 A1
(43) Pub. Date: Oct. 24, 2024

(54) POLYOLEFIN COMPOSITION FOR FILAMENTS OR FIBERS

(71) Applicant: Basell Polyolefine GmbH, Wesseling (DE)

(72) Inventors: Gianni Perdomi, Ferrara (IT); Roberta Marchini, Ferrara (IT); Gianluca Musacchi, Ferrara (IT)

(73) Assignee: Basell Polyolefine GmbH, Wesseling (DE)

(21) Appl. No.: 18/684,416

(22) PCT Filed: Aug. 12, 2022
(86) PCT No.: PCT/EP2022/072656

§ 371 Date: Feb. 16, 2024

(30) Foreign Application Priority Data
Aug. 18, 2021 (EP) 21191860.2

(51) Int. Cl. C08L 23/04; D01F 6/06

(52) U.S. Cl. CPC C08L 23/04; D01F 6/06; C08L 2203/12; C08L 2205/025; C08L 2205/03; D10B 2321/022

(57) ABSTRACT

A polyethylene composition made from or containing:
A) from 85% to 99% by weight of an ethylene polymer composition made from or containing:
   A^{I}) from 80 to 95% by weight of an ethylene polymer component, having a density D^{I} from 952 to 965 kg/m³ and a MIF of from 10 to 35 g/10 min.; and
   A^{II}) from 5 to 20% by weight of an ethylene polymer component, having a density D^{II} from 940 to 950 kg/m³ and a MIF value lower than the MIF value of A^{I});
   wherein the amounts of A^{I}) and A^{II}) are referred to the total weight of A^{I})+A^{II}); and
B) from 1% to 15% by weight of a butene-1 polymer component.

### FIELD OF THE INVENTION

In general, the present disclosure relates to the field of chemistry. More specifically, the present disclosure relates to polymer chemistry. In particular, the present disclosure relates to a polyolefin composition for filaments or fibers.

### BACKGROUND OF THE INVENTION

As used herein, the term “filaments” refers to fibers for textile and carpeting applications.

In some instances, the filaments have a titer of at least 50 denier (hereinafter called “den”).

In some instances, filaments are used for ropes and yarns for nets, geotextiles, and protective netting in agriculture and building industry.

### SUMMARY OF THE INVENTION

In a general embodiment, the present disclosure provides a polyolefin composition, hereinafter called “polyolefin composition (I)”, made from or containing:
A) from 85% to 99% by weight of an ethylene polymer composition made from or containing:
   A^{I}) from 80 to 95% by weight of an ethylene polymer component, having a density D^{I} from 952 to 965 kg/m³, determined according to ISO 1183-1:2012 at 23° C., and a MIF value (MIF^{I}) of from 10 to 35 g/10 min., wherein MIF is the Melt Flow Index MI measured according to ISO 1133-1:2011 at 190° C. with a load of 21.6 kg; and
   A^{II}) from 5 to 20% by weight of an ethylene polymer component, having a density D^{II} from 940 to 950 kg/m³ and a MIF value (MIF^{II}) lower than the MIF^{I} value of A^{I});
   wherein the amounts of A^{I}) and A^{II}) are referred to the total weight of A^{I})+A^{II}); and
B) from 1% to 15% by weight of a butene-1 polymer component;
   wherein the amounts of A) and B) are referred to the total weight of A)+B).

In some embodiments, component A) is from 85% to 99% by weight, alternatively from 88% to 98% by weight, alternatively from 92% to 98% by weight, of an ethylene polymer composition.

In some embodiments, the ethylene polymer component of component A) is made from or containing from 80 to 95% by weight, alternatively from 85 to 95% by weight, of component A^{I}).

In some embodiments, the ethylene polymer component of component A^{I}) has a density D^{I} from 952 to 965 kg/m³, alternatively from 955 to 965 kg/m³.

In some embodiments, the ethylene polymer component of component A^{I}) has a MIF value (MIF^{I}) of from 10 to 35 g/10 min., alternatively from 10 to 25 g/10 min.

In some embodiments, the ethylene polymer component of component A) is made from or containing from 5 to 20% by weight, alternatively from 5 to 15% by weight, of component A^{II}).

In some embodiments, the ethylene polymer component of component A^{II}) has a density D^{II} from 940 to 950 kg/m³, alternatively from 942 to 949 kg/m³, and a MIF value (MIF^{II}) lower than the MIF^{I} value of A^{I}), alternatively from 1 to 9 g/10 min.

In some embodiments, component B) is from 1% to 15% by weight, alternatively from 2% to 12% by weight, alternatively from 2% to 8% by weight, of a butene-1 polymer component. In some embodiments, the butene-1 polymer component of component B) has a flexural modulus value from 100 to 800 MPa, alternatively from 250 to 600 MPa, alternatively from 300 to 600 MPa.

In some embodiments, the present disclosure provides a filament or fiber made from or containing the polyolefin composition (I).

In some embodiments, other polyolefin components or components different from polyolefins are present in the filament or fiber. In some embodiments, the polyolefin composition (I) constitutes the overall polymer composition present in the filament or fiber, or part of such polymer composition, wherein the total weight of the filament or fiber is the sum of the polyolefin composition (I) and the other components.

In some embodiments, the present disclosure provides nets or ropes, alternatively anti hail nets or high tenacity ropes, made from or containing the filaments.

In some embodiments, the present disclosure provides textiles made from or containing the filaments or fibers. In some embodiments, the present disclosure provides textiles made from or containing filaments or fibers, oriented by stretching.

### DETAILED DESCRIPTION OF THE INVENTION

In some embodiments, the ethylene polymer components A^{I}) and A^{II}) are made from or containing one or more ethylene polymer(s) selected from the group consisting of ethylene homopolymers, ethylene copolymers, and mixtures thereof.

In some embodiments, the butene-1 polymer component B) is made from or containing one or more butene-1 polymer(s) selected from the group consisting of butene-1 homopolymers, butene-1 copolymers, and mixtures thereof.

As used herein, the term “copolymer” refers to polymers containing one kind or more than one kind of comonomer.

In some embodiments and in the ethylene copolymers, the comonomers are selected from olefins having the formula CH₂═CHR, wherein R is an alkyl radical, linear or branched, or an aryl radical, having 1 to 8 carbon atoms.

In some embodiments, the olefins, having the formula CH₂═CHR, are selected from the group consisting of propylene, butene-1, pentene-1, 4-methylpentene-1, hexene-1, octene-1, and decene-1.

In some embodiments, the olefins are selected from the group consisting of butene-1 and hexene-1.

In some embodiments and in the butene-1 copolymers, the comonomers are selected from the group consisting of ethylene, propylene, and olefins having formula CH₂═CHR, wherein R is an alkyl radical, linear or branched, or an aryl radical, having 3 to 8 carbon atoms. In some embodiments, the olefins are selected from the group consisting of pentene-1, 4-methylpentene-1, hexene-1, octene-1, and decene-1.

In some embodiments, the olefins are selected from the group consisting of ethylene, propylene, and hexene-1.

In some embodiments, the molecular weight distribution of the ethylene polymer components A^{I}) and A^{II}) is monomodal, bimodal, or multimodal. As used herein, the term “monomodal molecular weight distribution” refers to a molecular weight distribution, as determined with Gel Permeation Chromatography (GPC), having a single maximum. In some embodiments, the molecular weight distribution curve of a GPC-multimodal polymer is looked at as the superposition of the molecular weight distribution curves of two or more polymer subfractions and shows two or more distinct maxima or is at least distinctly broadened compared with the curves for the individual fractions.

In some embodiments, the ethylene polymer components A^{I}) and A^{II}) (independently from each other, or in any combination) have:
a MIP value of from 0.05 to 5 g/10 min. alternatively from 0.1 to 5 g/10 min., where MIP is the Melt Flow Index MI measured according to ISO 1133-1:2011 at 190° C. with a load of 5 kg;
a MIF/MIP value of from 5 to 40;
comonomer content of 8% by weight or lower, alternatively from 8% to 0.1% by weight, with respect to the total weight of the (co)polymer;
a Mw/Mn value of from 5 to 40, alternatively from 6 to 35, where Mw and Mn are the weight average molecular weight and the number average molecular weight respectively, measured by GPC (Gel Permeation Chromatography);
a Mw value of from 80000 g/mol to 500000 g/mol, alternatively from 150000 g/mol to 450000 g/mol. In some embodiments, the comonomer content is butene-1 content or hexene-1 content.

In some embodiments, Mw/Mn values for the ethylene polymer component A^{II}) are from 20 to 40, alternatively from 25 to 35.

In some embodiments, the ethylene polymer component A^{II}) has a Mz value equal to or higher than 1000000 g/mol, alternatively from 1000000 g/mol to 3500000 g/mol, alternatively from 1500000 g/mol to 3500000 g/mol, wherein Mz is the z-average molar mass measured by GPC.

In some embodiments, MIF/MIP values for the ethylene polymer component A^{I}) are from 5 to 15.

In some embodiments, MIF/MIP values for the ethylene polymer component A^{II}) are from 20 to 40, alternatively from 25 to 40.

In some embodiments, polyolefin compositions (I) have D^{I}-D^{II}, which is the difference between the density values of A^{I}) and A^{II}) respectively, from 5 to 15 kg/m³, alternatively from 8 to 13 kg/m^{3.}

In some embodiments, polyolefin compositions (I) have MIF^{I}-MIF^{II}, which is the difference between the MIF values of A^{I}) and A^{II}) respectively, from 5 to 20 g/10 min, alternatively from 8 to 15 g/10 min, independently or in combination with the values of D^{I}-D^{II}.

In some embodiments ethylene polymer components A^{I}) and A^{II}) are commercially available.

In some embodiments ethylene polymer components A^{I}) and A^{II}) are produced by using a Ziegler-Natta catalyst system.

In some embodiments, a Ziegler-Natta catalyst is made from or containing the product of a reaction of an organometallic compound of group 1, 2 or 13 of the Periodic Table of elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal compound is supported on MgCl₂.

In some embodiments, the catalysts are made from or containing the product of the reaction of the organometallic compound of group 1, 2 or 13 of the Periodic Table of elements, with a solid catalyst component made from or containing a Ti compound supported on MgCl₂.

In some embodiments, the organometallic compounds are organo-Al compounds.

In some embodiments, the ethylene polymer components A^{I}) and A^{II}) are obtainable by using a Ziegler-Natta polymerization catalyst, alternatively a Ziegler-Natta catalyst supported on MgCl₂, alternatively a Ziegler-Natta catalyst made from or containing the product of reaction of:
a) a solid catalyst component made from or containing a Ti compound and an electron donor compound ED (internal electron donor) supported on MgCl₂;
b) an organo-Al compound; and optionally
c) an external electron donor compound ED_{ext.}

In some embodiments and in component a), the ED/Ti molar ratio ranges from 1.5 to 3.5 and the Mg/Ti molar ratio is higher than 5.5, alternatively from 6 to 80.

In some embodiments, the titanium compounds are the tetrahalides or the compounds of formula TiXn(OR¹)₄₋ₙ, where 0≤n≤3, X is halogen, and R¹ is C₁-C₁₀ hydrocarbon group. In some embodiments, X is chlorine. In some embodiments, the titanium compound is titanium tetrachloride.

In some embodiments, the ED compound is selected from the group consisting of alcohols, ketones, amines, amides, nitriles, alkoxysilanes, aliphatic ethers, and esters of aliphatic carboxylic acids.

In some embodiments, the external electron donor compound EDₑₓₜ optionally used to prepare the Ziegler-Natta catalysts is the same as or different from the ED used in the solid catalyst component a). In some embodiments, the external electron donor compound EDₑₓₜ is selected from the group consisting of ethers, esters, amines, ketones, nitriles, silanes, and mixtures thereof. In some embodiments, the external electron donor compound EDₑₓₜ is selected from C2-C20 aliphatic ethers, alternatively cyclic ethers, alternatively cyclic ethers having 3-5 carbon atoms. In some embodiments, the external electron donor compound EDext is selected from the group consisting of tetrahydrofuran and dioxane.

In some embodiments, the ethylene polymer components A^{I}) and A^{II}) are produced by using one or more single site catalysts. In some embodiments, the single site catalysts are selected from the group consisting of metallocene and non-metallocene single site catalysts.

In some embodiments, the polymerization is continuous or batch. In some embodiments, the polymerization is carried out in liquid phase, in the presence or not of inert diluent, or in gas phase, or by mixed liquid-gas techniques.

In some embodiments, the ethylene polymer components A^{I}) and/or A^{II}) are multimodal, and the polymerization process is carried out in two or more reactors connected in series, wherein the polymer subfractions are prepared in separate subsequent stages, operating in each stage, except for the first stage, in the presence of the polymer formed and the catalyst used in the preceding stage.

In some embodiments, the catalyst is added in the first reactor and not subsequent reactors. In some embodiments, the catalyst is added in more than the first reactor.

In some embodiments, the reaction temperature is from 50 to 100° C. In some embodiments, the reaction pressure is atmospheric or higher.

In some embodiments, the molecular weight is regulated. In some embodiments, the molecular weight regulator is hydrogen.

In some embodiments, the butene-1 polymer component B) is commercially available.

In some embodiments, the butene-1 polymer component B) is a linear polymer, which is highly isotactic.

In some embodiments, the butene-1 polymer component B) has an isotacticity from 90 to 99%, alternatively from 93 to 99%, alternatively from 95 to 99%, measured as mmmm pentads/total pentads with ¹³C-NMR operating at 150.91 MHz, or as quantity by weight of matter soluble in xylene at 0° C.

In some embodiments, the butene-1 polymer component B) has a MIE value of from 0.05 to 50 g/10 min., alternatively from 0.1 to 10 g/10 min., where MIE is the Melt Flow Index MI at 190° C. with a load of 2.16 kg, determined according to ISO 1133-1:2011.

In some embodiments, the MI value at 190° C. with a load of 10 kg, determined according to ISO 1133-1:2011, of the butene-1 polymer component B) is of 1 to 1300 g/10 min., alternatively of 2 to 250 g/10 min.

In some embodiments, the butene-1 polymer component B) is a homopolymer.

In some embodiments, the butene-1 polymer B) is a copolymer having a comonomer content, alternatively a copolymerized ethylene content. In some embodiments, the comonomer content is of from 0.5% to 10% by mole, alternatively of from 0.7% to 9% by mole.

In some embodiments, the butene-1 polymer component B) is a butene-1 polymer composition made from or containing:
B1) a butene-1 homopolymer or a copolymer of butene-1 with at least one comonomer selected from the group consisting of ethylene, propylene, the previously-defined CH₂═CHR olefins, and mixtures thereof, having a copolymerized comonomer content of up to 2% by mole;
B2) a copolymer of butene-1 with at least one comonomer selected from the group consisting of ethylene, propylene, the previously-defined CH₂═CHR olefins, and mixtures thereof, having a copolymerized comonomer content of from 3 to 5% by mole;
wherein the butene-1 polymer composition having a total copolymerized comonomer content of 0.5-4.0% by mole, alternatively of from 0.7 to 3.5% by mole, referred to the sum of B1)+B2).

In some embodiments, the relative amounts of B1) and B2) range from 10% to 40% by weight, alternatively from 15% to 35% by weight, of B1) and from 90% to 60% by weight, alternatively from 85% to 65% by weight, of B2), wherein the amounts being referred to the sum of B1)+B2).

In some embodiments, the butene-1 polymer component B) has at least one of the following additional features:
a molecular weight distribution (Mw/Mn) equal to or lower than 9, alternatively equal to or lower than 8;
a melting point TmII, measured by DSC (Differential Scanning Calorimetry) in the second heating run with a scanning speed of 10° C./min., equal to or lower than 125° C., alternatively equal to or lower than 120° C.; or
an X-ray crystallinity of from 25 to 65%.
   In some embodiments, the lower limit of the molecular weight distribution is 1.5. In some embodiments, the lower limit of the melting point TmII is 75° C.

In some embodiments, the butene-1 polymer component B) has at least one of the following additional features:
an intrinsic viscosity (I.V.) measured in tetrahydronaphthalene (THN) at 135° C., equal to or lower than 5 dl/g, alternatively equal to or lower than 3 dl/g;
an Mw equal to or greater than 100000 g/mol, alternatively from 100000 to 650000 g/mol;
a melting point TmI, measured by DSC with a scanning speed of 10° C./min., from 95° C. to 135° C.; or
a density of 885-925 kg/m³, alternatively of 900-920 kg/m³, alternatively of 912-920 kg/m³.
   In some embodiments, the lower limit of the intrinsic viscosity (I.V.), measured in tetrahydronaphthalene (THN) at 135° C., is 0.4 dl/g.

In some embodiments, the butene-1 polymer component B) is produced using TiCl₃ based Ziegler-Natta catalysts and aluminum derivatives as cocatalysts, as well as the catalytic systems supported on MgCl₂ described above for the preparation of the ethylene polymer components A^{I}) and A^{II}). In some embodiments, the aluminum derivatives are aluminum halides.

In some embodiments, supported catalytic systems are used with internal electron donor compounds selected from the group consisting of diethyl 3,3-dimethyl glutarate and diisobutyl 3,3-dimethyl glutarate.

In some embodiments, external electron donor compounds are selected from the group consisting of cyclohexyltrimethoxysilane, t-butyltrimethoxysilane diisopropyltrimethoxysilane, and thexyltrimethoxysilane. In some embodiments, the external electron donor compound is thexyltrimethoxysilane.

In some embodiments, the butene-1 polymer component B) is obtained by polymerizing the monomer(s) in the presence of a metallocene catalyst system obtainable by contacting:
a stereorigid metallocene compound;
an alumoxane or a compound capable of forming an alkyl metallocene cation; and, optionally,
an organo aluminum compound.

In some embodiments, the polymerization process is carried out with the catalysts by operating in liquid phase, optionally in the presence of an inert hydrocarbon solvent, or in gas phase, using fluidized bed or mechanically agitated gas phase reactors.

In some embodiments, the hydrocarbon solvent is aromatic or aliphatic. In some embodiments, the aromatic solvent is toluene. In some embodiments, the aliphatic solvent is selected from the group consisting of propane, hexane, heptane, isobutane, cyclohexane, 2,2,4-trimethylpentane, and isododecane).

In some embodiments, the polymerization process is carried out by using liquid butene-1 as polymerization medium.

In some embodiments, the polymerization temperature is from 20° C. to 150° C., alternatively from 50° C. to 90° C., alternatively from 65° C. to 82° C.

In some embodiments, a molecular weight regulator, alternatively hydrogen, is fed to the polymerization environment.

In some embodiments, the process is a multistep polymerization process, wherein butene-1 polymers with different composition or molecular weights are prepared in sequence in two or more reactors with different reaction conditions. In some embodiments, the concentration of molecular weight regulator differs. In some embodiments, different comonomers are fed to each reactor.

In some embodiments, the butene-1 polymer component B) is made from or containing components B1) and B2), wherein the polymerization process is carried out in two or more reactors connected in series and components B1) and B2) are prepared in separate subsequent stages, operating in each stage, except for the first stage, in the presence of the polymer formed and the catalyst used in the preceding stage.

In some embodiments, the catalyst is added in the first reactor and not subsequent reactors. In some embodiments, the catalyst is added in more than the first reactor.

In some embodiments, the MI values of the polymer components are obtained directly in polymerization. In some embodiments and for the butene-1 polymer component, the MI values are obtained by subsequent chemical treatment (chemical visbreaking).

In some embodiments, the chemical visbreaking of the polymer is carried out in the presence of free radical initiators, alternatively peroxides.

In some embodiments, the peroxides have a decomposition temperature ranging from 150° C. to 250° C. In some embodiments, the peroxides are selected from the group consisting of di- tert-butyl peroxide, dicumyl peroxide, 2,5-dimethyl-2,5-di(tert-butylperoxy)hexyne, and 2,5-dimethyl-2,5-di(tert-butylperoxy)hexane. In some embodiments, the peroxides are commercially available.

In some embodiments, the quantity of peroxide ranges from 0.001 to 0.5% by weight, alternatively from 0.001 to 0.2%, of the polymer.

In some embodiments, the polyolefin composition (I) is obtainable by melting and mixing the components, and the mixing is effected in a mixing apparatus at temperatures from 180 to 310° C., alternatively from 190 to 280° C., alternatively from 200 to 250° C.

In some embodiments, the melt-mixing apparatuses are extruders or kneaders, alternatively twin-screw extruders. In some embodiments, the components are premixed at room temperature in a mixing apparatus.

In some embodiments, the polyethylene composition (I) was further made from or containing additives. In some embodiments, the additives were selected from the group consisting of stabilizing agents (against heat, light, or U.V.), plasticizers, antiacids, antistatic, water repellant agents, and pigments.

In some embodiments, the filament or fiber is made from or containing at least 70% by weight, alternatively at least 80% by weight, alternatively at least 90% by weight, alternatively at least 95% by weight, of polyethylene composition (I), with respect to the total weight of the filament or fiber, the upper limit being 100% by weight in the cases.

In some embodiments, the filaments have a rounded (circular, oval, lenticular, or multilobal) cross-section. In some embodiments, the filaments have an angular, like rectangular, cross-section.

As used herein, the filaments having rounded cross-section are referred to as “monofilaments.” As used herein, the filaments having angular, alternatively rectangular, cross-section are referred to as “tapes”. As used herein, the term “filament” includes monofilaments and tapes.

In some embodiments, the tapes have a thickness from 0.03 to 1 mm and a width from 2 to 20 mm.

In some embodiments, the filaments have a titer of at least 50 den.

In some embodiments, the titer values for the filaments are at least 70 den, alternatively at least 100 or 200, alternatively at least 500 den. In some embodiments, the upper limit is 7000 den for monofilaments and 25000 den for tapes.

In some embodiments, the filament is stretched. In some embodiments, the stretching ratios are from 1.5 to 10 (1.5:1 to 10:1), alternatively from 3 to 10 (3:1 to 10:1). In some embodiments, the stretching ratios apply to the fibers.

In some embodiments, tenacity values for the filaments are of 5 g/den or higher, alternatively from 5 to 7, alternatively from 5 to 6 for a stretching ratio of 7:1 or lower, alternatively from 5.5 to 7 for a stretching ratio of 8:1 or higher.

In some embodiments, values of elongation at break for the filaments are of 25% or higher, alternatively from 25% to 55%, alternatively from 25% to 35% for a stretching ratio of 8:1 or higher, alternatively from 30% to 55% for a stretching ratio of 7:1 or lower.

In some embodiments, the filaments are made from or containing components made of materials different from polyolefins. In some embodiments, the filaments are made from or containing embedded reinforcing fibers. In some embodiments, the materials different from polyolefins are polyamide.

In some embodiments, the filaments are used in the form of bundles for preparation of various finished articles.

In some embodiments, bundles of filaments are obtained by fibrillation of tapes.

In some embodiments, the process for preparing polyolefin filaments includes the steps of:
(a) melting the polyethylene composition (I) and, when present, the other polymer components;
(b) spinning the filaments or extruding a precursor film or tape;
(c) optionally stretching the filaments or the precursor film or tape or cutting the precursor film or tape and optionally stretching the filaments, when no stretching is previously carried out; and
(d) optionally finishing the filaments obtained from step (b) or (c).

In some embodiments, the melting step (a) and the spinning or extrusion step (b) are carried out continuously in sequence by using mono-or twin-screw extruders, equipped with a spinning or extrusion head. In some embodiments, the melt-mixing step is carried out in the same spinning or extrusion apparatus.

In some embodiments, the spinning heads have a plurality of holes with the same shape as the transversal section of the filament (monofilament or tape).

In some embodiments, the film extrusion heads are flat or annular dies used for the film preparation.

In some embodiments, a precursor film or tape is obtained in step (b) and then processed in step (c) by cutting the precursor film or tape into tapes of a certain size. In some embodiments, the stretching treatment is carried out on the precursor film or tape and not on the final filament.

In some embodiments, the finishing treatments are selected from the group consisting of fibrillation and crimping.

In some embodiments, fibrillation is carried out on tapes.

In some embodiments, the melting step (a) and the spinning or extrusion step (b) are carried out at the same temperatures as for the melt-mixing step. In some embodiments, the temperatures are from 180 to 310° C., alternatively from 190 to 280° C., alternatively from 200 to 250° C.

In some embodiments, the spinning conditions are:
temperature in the extruder head from 200 to 300° C.; and
take-up speed for primary web (unstretched) from 1 to 50 m/min.

In some embodiments, the film extrusion conditions are:
temperature in the extruder head from 200 to 300° C.; and
output value from 20 to 1000 kg/hour (on industrial plants).

In some embodiments, the filament or the precursor film obtained in step (b) are cooled. In some embodiments, cooling is achieved with one or more chill rolls. In some embodiments, cooling is achieved with by immersion in water at a temperature from 5 to 40° C.

To carry out the stretching treatment, the filament (monofilament or tape) or the precursor tape are previously heated at a temperature from 40 to120-140° C. In some embodiments, heating is achieved by using a hot air oven, a boiling water bath, or heated rolls or by irradiation.

In some embodiments, stretching is achieved by delivering the precursor tape or filament through a series of rollers having different rotation speeds.

As used herein, the term “stretching ratio” refers to the ratio between the high speed of the rollers of the stretching unit and the speed of the rollers of the take-off unit (primary speed). In some embodiments and in the take-off unit, the tape or filament moving at low speed is heated before being stretched by applying faster speed.

In some embodiments, fibrillation is achieved by feeding the tape between rolls. In some embodiments, the rolls cut longitudinally or diagonally.

In some embodiments, fibers with lower denier than filaments are prepared by extruding the polymer melt through the spinning heads, wherein the holes have a smaller diameter with respect to the diameter used for filaments. In some embodiments, the denier of the fibers is under 50 den, alternatively from 1 to 15 den. In some embodiments, the fibers emerging from the spinning head are subsequently subjected to quenching and oriented by stretching.

### EXAMPLES

The following examples are given to illustrate the present disclosure, not limit the scope of the appended claims or the present disclosure.

The following analytical methods are used to characterize the polymer compositions and filaments.

### Density

Determined according to ISO 1183-1:2012 at 23° C.

### Melt Flow Index MI

Determined according to ISO 1133-1:2011 with the specified temperature and load.

### Intrinsic Viscosity I.V.

The sample was dissolved in tetrahydronaphthalene at 135° C. and then poured into a capillary viscometer. The viscometer tube (Ubbelohde type) was surrounded by a cylindrical glass jacket; this setup allowed for temperature control with a circulating thermostatic liquid. The downward passage of the meniscus was timed by a photoelectric device.

The passage of the meniscus in front of the upper lamp started the counter which had a quartz crystal oscillator. The counter stopped as the meniscus passed the lower lamp. The efflux time was registered and converted into a value of intrinsic viscosity through Huggins' equation (Huggins, M.L., J. Am. Chem. Soc., 1942, 64, 2716), using the flow time of the pure solvent at the same experimental conditions (same viscometer and same temperature). A single polymer solution was used to determine I. V.

### Molecular Weight Distribution Determination

For the ethylene polymers, the determination of the molar mass distributions and the means Mn, Mw, and Mz and the ratio Mw/Mn derived therefrom was carried out by high-temperature gel permeation chromatography using a method described in ISO 16014-1,-2,-4, issues of 2003. The specifics according to the mentioned ISO standards were as follows: Solvent 1,2,4-trichlorobenzene (TCB), temperature of apparatus and solutions 135° C. and, as concentration detector, a PolymerChar (Valencia, Paterna 46980, Spain) IR-4 infrared detector, for use with TCB. A WATERS Alliance 2000 equipped with pre-column SHODEX UT-G and separation columns SHODEX UT 806 M (3x) and SHODEX UT 807 (Showa Denko Europe GmbH, Konrad-Zuse-Platz 4, 81829 Muenchen, Germany) connected in series was used.

The solvent was vacuum distilled under nitrogen and stabilized with 0.025% by weight of 2,6-di-tert-butyl-4-methylphenol. The flowrate used was 1 ml/min. The injection was 500μl. The polymer concentration was in the range of 0.01% <conc.<0.05% w/w. The molecular weight calibration was established by using monodisperse polystyrene (PS) standards from Polymer Laboratories (now Agilent Technologies, Herrenberger Str. 130, 71034 Boeblingen, Germany)) in the range from 580 g/mol up to 11600000 g/mol and additionally with hexadecane.

The calibration curve was then adapted to Polyethylene (PE) by the Universal Calibration method (Benoit H., Rempp P. and Grubisic Z., & in J. Polymer Sci., Phys. Ed., 5, 753 (1967)). The Mark-Houwink parameters used were for PS:k_{PS}=0.000121 dl/g, α_{PS}=0.706 and for PE K_{PE}=0.000406 dl/g, α_{PE}=0.725, valid in TCB at 135° C. Data recording, calibration, and calculation were carried out using NTGPC_Control_V6.02.03 and NTGPC_V6.4.24 (hs GmbH, Hauptstraße 36, D-55437 Ober-Hilbersheim, Germany) respectively.

For the butene-1 polymers, the determination of the molar mass distributions and the means Mn, Mw, and Mz and the ratio Mw/Mn derived therefrom was carried out by using a GPC-IR apparatus by PolymerChar, which was equipped with a column set of four PLgel Olexis mixed-bed (Polymer Laboratories) and an IR5 infrared detector (PolymerChar). The dimensions of the columns were 300×7.5 mm, and the particle size was 13 μm. The mobile phase flow rate was kept at 1.0 mL/min. The measurements were carried out at 150° C. Solution concentrations were 2.0 mg/mL (at 150° C.), and 0.3 g/L of 2,6-di-tert-butyl-p-cresol were added, thereby preventing degradation. For GPC calculation, a universal calibration curve was obtained using 12 polystyrene (PS) standard samples supplied by PolymerChar (peak molecular weights ranging from 266 to 1220000). A third-order polynomial fit was used for interpolating the experimental data and obtaining the calibration curve. Data acquisition and processing was done by using Empower 3 (Waters). The Mark-Houwink relationship was used to determine the molecular weight distribution and the average molecular weights: the K values were K_{PS}=1.21×10⁻⁴ dL/g and K_{PB}=1.78×10⁻⁴ dL/g for PS and polybutene (PB) respectively, while the Mark-Houwink exponents α=0.706 for PS and α=0.725 for PB were used.

For butene/ethylene copolymers, the composition of each sample was assumed constant in the whole range of molecular weight, and the K value of the Mark-Houwink relationship was calculated using a linear combination as reported below:

$${K}_{E B} = {x}_{E} {K}_{P E} + {x}_{B} {K}_{P B}$$

where K_{EB} is the constant of the copolymer, K_{PE}(4.06×10⁻⁴, dL/g) and K_{PB}(1.78×10⁻⁴ dL/g) are the constants of polyethylene (PE) and PB, x_{E} and x_{B} are the ethylene and the butene weight relative amount with x_{E}+x_{B}=1. The Mark-Houwink exponents α=0.725 was used for the butene/ethylene copolymers independently of composition. End processing data treatment was fixed for the samples to include fractions up at 1000 in terms of molecular weight equivalent. Fractions below 1000 were investigated via GC.

### Comonomer Content

The comonomer content of the ethylene polymers was determined by IR in accordance with ASTM D 6248 98, using an FT-IR spectrometer Tensor 27 from Bruker, calibrated with a chemometric model for determining ethyl-or butyl-side-chains in PE for butene or hexene as comonomer, respectively. The result was compared to the estimated comonomer content derived from the mass-balance of the polymerization process and found to agree.

The comonomer content of the butene-1 polymers was determined via FT-IR.

The spectrum of a pressed film of the polymer was recorded in absorbance vs. wavenumbers (cm⁻¹). The following measurements were used to calculate the ethylene content:
a) area (Aₜ) of the combination absorption bands between 4482 and 3950 cm⁻¹ which was used for spectrometric normalization of film thickness.
b) factor of subtraction (FCR_{C2}) of the digital subtraction between the spectrum of the polymer sample and the absorption band due to the sequences BEE and BEB (B: 1,butene units, E: ethylene units) of the methylenic groups (CH₂ rocking vibration).
c) Area (A_{C2,block}) of the residual band after subtraction of the C₂PB spectrum, which comes from the sequences EEE of the methylenic groups (CH₂ rocking vibration).

### APPARATUS

A Fourier Transform Infrared spectrometer (FTIR) was used.

A hydraulic press with platens heatable to 200° C. (Carver or equivalent) was used.

### METHOD

### Calibration of (BEB+BEE) Sequences

A calibration straight line was obtained by plotting %(BEB+BEE) wt vs. FCR_{C2}/Aₜ. The slope Gᵣ and the intercept Iᵣ were calculated from a linear regression.

### Calibration of EEE sequences

A calibration straight line was obtained by plotting %(EEE) wt vs. A_{C2,block}/Aₜ. The slope G_{H} and the intercept I_{H} were calculated from a linear regression.

### Sample Preparation

Using a hydraulic press, a thick sheet was obtained by pressing about 1.5 grams of sample between two aluminum foils. If homogeneity was uncertain, a minimum of two pressing operations occurred. A small portion was cut from this sheet to mold a film. The film thickness was between 0.1-0.3 mm.

The pressing temperature was 140±10° C.

Because a crystalline phase modification takes place with time, the IR spectrum of the sample film was collected as soon as the sample was molded.

### Procedure

The instrument data acquisition parameters were as follows:
Purge time: 30 seconds minimum.
Collect time: 3 minutes minimum.
Apodization: Happ-Genzel.
Resolution: 2 cm⁻¹.
Collect the IR spectrum of the sample vs. an air background.

### CALCULATION

Calculate the concentration by weight of the BEE+BEB sequences of ethylene units:

$$\% ( BEE + BEB ) wt = {G}_{r} \cdot \frac{F C {R}_{C 2}}{{A}_{t}} + {I}_{r}$$

Calculate the residual area (AC2,block) after the subtraction described above, using a baseline between the shoulders of the residual band.

Calculate the concentration by weight of the EEE sequences of ethylene units:

$$\% ( EEE ) wt = {G}_{H} \cdot \frac{{A}_{C2 , block}}{{A}_{t}} + {I}_{H}$$

Calculate the total amount of ethylene percent by weight:

$$\% C 2 wt = [ \% ( BEE + B EB ) wt + \% ( EEE ) wt ]$$

### Determination of X-ray Crystallinity

The X-ray crystallinity was measured with an X-ray Diffraction Powder Diffractometer (XDPD) that uses the Cu-Kal radiation with fixed slits and able to collect spectra between diffraction angle 2Θ=5° and 2Θ=35° with step of 0.1° per 6 seconds.

The samples were diskettes of about 1.5-2.5 mm of thickness and 2.5-4.0 cm of diameter made by compression molding. The diskettes were aged at room temperature (23° C.) for 96 hours.

After this preparation, the specimen was inserted in the XDPD sample holder. The XRPD instrument was set to collect the XRPD spectrum of the sample from diffraction angle 2Θ=5° to 2Θ=35° with steps of 0.1° by using counting time of 6 seconds. At the end, the final spectrum was collected.

As used herein, the term “Ta” refers to the total area between the spectrum profile and the baseline, expressed in counts/sec·2Θ. As used herein, the term “Aa” refers to the total amorphous area, expressed in counts/sec·2Θ. As used herein, the term “Ca” refers to total crystalline area, expressed in counts/sec·2Θ.

The spectrum or diffraction pattern was analyzed in the following steps:
1) define a linear baseline for the whole spectrum and calculate the total area (Ta) between the spectrum profile and the baseline;
2) define an amorphous profile, along the whole spectrum, that separates the amorphous regions from the crystalline regions, according to the two-phase model;
3) calculate the amorphous area (Aa) as the area between the amorphous profile and the baseline;
4) calculate the crystalline area (Ca) as the area between the spectrum profile and the amorphous profile as Ca=Ta−Aa; and
5) calculate the degree of crystallinity (% Cr) of the sample using the formula:

$$\% Cr = 100 \times Ca / Ta$$

### Melting and Crystallization Temperatures of Butene-1 Polymer B) via Differential Scanning Calorimetry (DSC)

Differential scanning calorimetric (DSC) data were obtained with a Perkin Elmer DSC-7 instrument, using a weighed sample (5-10 mg) sealed into aluminum pans.

To determine the melting temperature of the polybutene-1 crystalline form I (TmI), the sample was heated to 200° C. with a scanning speed corresponding to 10° C./minute, kept at 200° C. for 5 minutes, and then cooled down to 20° C. with a cooling rate of 10° C./min. The sample was then stored for 10 days at room temperature. After 10 days, the sample was subjected to DSC, cooled to −20° C., and then heated to 200° C. with a scanning speed corresponding to 10° C./min. In this heating run, the highest temperature peak in the thermogram was taken as the melting temperature (TmI).

To determine the melting temperature of the polybutene-1 crystalline form II (TmII) and the crystallization temperature T_{c}, the sample was heated to 200° C. with a scanning speed corresponding to 10° C./minute and kept at 200° C. for 5 minutes, thereby allowing melting of the crystallites and cancelling the thermal history of the sample. Successively, by cooling to −20° C. with a scanning speed corresponding to 10° C./minute, the peak temperature was taken as crystallization temperature (T_{c}) and the area as the crystallization enthalpy. After standing 5 minutes at −20° C., the sample was heated for the second time to 200° C. with a scanning speed corresponding to 10° C./min. In this second heating run, the peak temperature was taken as the melting temperature of the polybutene-1 crystalline form II (TmII) and the area as the melting enthalpy (ΔHfII).

### NMR Analysis of Chain Structure

¹³C NMR spectra were acquired on a Bruker AV-600 spectrometer equipped with cryo-probe, operating at 150.91 MHz in the Fourier transform mode at 120° C.

The peak of the T_{βδ}carbon (nomenclature according to C. J. Carman, R. A. Harrington and C. E. Wilkes, Macromolecules, 10, 3, 536 (1977)) was used as internal standard at 37.24 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H—¹³C coupling. About 512 transients were stored in 32K data points using a spectral window of 9000 Hz.

The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:

$$\begin{matrix}BBB = 100 ( {T}_{β β} ) / S = I 5 \\ BBE = 100 {T}_{β δ} / S = I 4 \\ EBE = 100 {P}_{δ δ} / S = I 14 \\ BEB = 100 {S}_{β β} / S = I 13 \\ BEE = 100 {S}_{α δ} / S = I 7 \\ EEE = 100 ( 0.25 {S}_{γ δ} + 0.5 {S}_{δ δ} ) / S = 0.25 I 9 + 0.5 I 10\end{matrix}$$

| Area | Chemical Shift | Assignments | Sequence |
|---|---|---|---|
| 1 | 40.40-40.14 | Sαα | BBBB |
| 2 | 39.64 | Tδδ | EBE |
| | 39-76-39.52 | Sαα | BBBE |
| 3 | 39.09 | Sαα | EBBE |
| 4 | 37.27 | Tβδ | BBE |
| 5 | 35.20-34.88 | Tββ | BBB |
| 6 | 34.88-34.49 | Sαγ | BBEB + BEBE |
| 7 | 34.49-34.00 | Sαδ | EBEE + BBEE |
| 8 | 30.91 | Sγγ | BEEB |
| 9 | 30.42 | Sγδ | BEEE |
| 10 | 29.90 | Sδδ | EEE |
| 11 | 27.73-26.84 | Sβδ + 2B₂ | BBB + BBE |
| | | | EBEE + BBEE |
| 12 | 26.70 | 2B₂ | EBE |
| 13 | 24.54-24.24 | Sββ | BEB |
| 14 | 11.22 | Pδδ | EBE |
| 15 | 11.05 | Pβδ | BBE |
| 16 | 10.81 | Pββ | BBB |

To a first approximation, the mmmm was calculated using 2B2 carbons as follows:

| Area | Chemical shift | assignments |
|---|---|---|
| B1 | 28.2-27.45 | mmmm |
| B2 | 27.45-26.30 | |

$$m m m m = {B}_{1} * 100 / ( {B}_{1} + {B}_{2 -} 2 * {A}_{4 -} {A}_{7 -} {A}_{14} )$$

### Tenacity, Elongation at Break and Load at Break of Filaments

In some instances, titer in deniers is used to measure the size of textile fibers and filaments. As used herein, the term “titer” refers to the weight (in grams) of 9000 m of filament or tape. At laboratory scale, the titer (in deniers) is determined by multiplying the weight of 100 m of filament or tape by 90 times.

Tenacity and elongation at break are measured by using a dynamometer on a single filament, with clamps distance of 250 mm and applied elongation speed of 250 mm/min. In some instances, the dynamometer was a LLOYD RX-Plus.

The load cell provides the load at break (in grams or Kg) while elongation at break (%) is calculated as follows:

$$( clamps distance at break - initial clamps distance / initial clamps distance ) * 100.$$

The tenacity (at break) was obtained by dividing the load at break (in grams) by the titer in deniers.

### Flexural Modulus

According to norm ISO 178:2010, measured 10 days after molding.

### Examples 1 and 2 and Comparative Examples 1 to 3

The following materials were used to prepare the polyolefin composition (I).

### Ethylene Polymer Component A^{I})

Bimodal ethylene copolymer was prepared with a Ziegler-Natta catalyst, having the properties reported in Table I below.

The bimodal ethylene copolymer was commercially available under the trademark Hostalen GF 7750 M3, from LyondellBasell.

### Ethylene Polymer Component A^{II})

Trimodal ethylene copolymer was prepared with a Ziegler-Natta catalyst, having the properties reported in Table I below.

The trimodal ethylene copolymer was commercially available under the trademark Hostalen ACP 9240 PLUS, from LyondellBasell.

### Butene-1 Polymer Component B)

Butene-1 homopolymer was prepared with a Ziegler-Natta catalyst in liquid monomer polymerization, having the properties reported in Table I below.

The butene-1 homopolymer was commercially available under the trademark Toppyl PB 0110M, from LyondellBasell.

TABLE I

| A^{I} | |
|---|---|
| Density [kg/m³] | 957 |
| MIF [g/10 min.] | 18 |
| MIP [g/10 min.] | 1.7 |
| MIF/MIP | 10.6 |
| Mw [g/mol] | 171594 |
| Mn [g/mol] | 22640 |
| Mw/Mn | 7.6 |
| A^{II} | |
| Density [kg/m³] | 946 |
| MIF [g/10 min.] | 6 |
| MIP [g/10 min.] | 0.2 |
| MIF/MIP | 30 |
| Mw [g/mol] | 347475 |
| Mn [g/mol] | 11076 |
| Mw/Mn | 31.4 |
| B | |
| Flexural Modulus [MPa] | 450 |
| MIE [g/10 min.] | 0.4 |
| MI 190° C./10 kg [g/10 min.] | 12 |
| Density [kg/m³] | 914 |
| TmI [° C.] | 128 |
| TmII [° C.] | 117 |
| Mw/Mn | 7.4 |

### Preparation of the Polyolefin Composition (I)

Components A^{I}), A^{II}), and B) were mixed with a stabilizing additive composition and blended together by extrusion in a twin screw extruder Berstorff ZE 25 (length/diameter ratio of screws: 34) under nitrogen atmosphere in the following conditions:
Rotation speed: 250 rpm;
Extruder output: 15 kg/hour,
Melt temperature: 245° C.

The stabilizing additive composition was made of the following components:
0.1% by weight of Irganox® 1010;
0.1% by weight of Irgafos® 168; and
0.2% by weight of calcium stearate;
   where the percent amounts refer to the total weight of the polymer and stabilizing additive composition.

The Irganox® 1010 is 2,2-bis[3-[,5-bis(1,1-dimethylethyl)-4-hydroxyphenyl) -1-oxopropoxy]methyl]-1,3-propanediyl-3,5-bis(1,1-dimethylethyl)-4-hydroxybenzene-propanoate, while Irgafos® 168 was tris(2,4-di-tert.-butylphenyl)phosphite.

The resulting polyethylene composition (I) was spun into filaments with circular cross-section.

The apparatus used was an extruder Leonard, 25 mm diameter, 27 L/D long +Gear pump. The die had 10 holes, circular shaped, with a diameter of 1.2 mm.

The main process conditions were:
Temperature profile: Cylinder 180-185-190-195° C.;
   Pump 200° C.;
   Adapter 205° C.;
   Head-die 210° C.;
Melt temperature: 212+/−3° C.;
Output used: around 4 kg/h;
Cooling water bath: 21+/−1° C.;
Stretching oven set: 106+/−2° C. (hot air);
Stretching ratio used: 1:7 and 1:8;
Annealing oven set: 106+/−2° C. (hot air);
Annealing factor: average −5.0% (slower).

The properties of the resulting filaments are reported in Table II.

TABLE II

| Example No. | 1 | 2 | Comp. 1 | Comp. 2 | Comp. 3 |
|---|---|---|---|---|---|
| Amount of A^{I}) | 85 | 80 | 100 | 95 | 90 |
| [% by weight] | | | | | |
| Amount of A^{II}) | 10 | 10 | 0 | 0 | 10 |
| [% by weight] | | | | | |
| Amount of B) | 5 | 10 | 0 | 5 | 0 |
| [% by weight] | | | | | |
| Stretching ratio 7:1 | | | | | |
| Titer [den.] | 620 | 610 | 620 | 625 | 605 |
| Tenacity [g/den] | 5.1 | 5.1 | 4.7 | 4.6 | 4.8 |
| Elongation at | 44 | 37 | 65 | 58 | 41 |
| Break [%] | | | | | |
| Load at Break [kg] | 3.2 | 3.1 | 2.9 | 3.9 | 2.9 |
| Stretching ratio 8:1 | | | | | |
| Titer [den.] | 610 | 630 | 610 | 615 | 620 |
| Tenacity [g/den] | 6.0 | 5.9 | 4.6 | 5.6 | 5.5 |
| Elongation at | 30 | 29 | 58 | 35 | 32 |
| Break [%] | | | | | |
| Load at Break [kg] | 3.7 | 3.7 | 2.8 | 3.4 | 3.4 |

1. A polyolefin composition (I) comprising:
A) from 85% to 99% by weight of an ethylene polymer composition comprising:
A^{I}) from 80 to 95% by weight of an ethylene polymer component, having a density D^{I} from 952 to 965 kg/m³, determined according to ISO 1183-1:2012 at 23° C., and a MIF value (MIF^{I}) of from 10 to 35 g/10 min., wherein MIF is the Melt Flow Index MI measured according to ISO 1133-1:2011 at 190° C. with a load of 21.6 kg; and
A^{II}) from 5 to 20% by weight of an ethylene polymer component, having a density D^{II} from 940 to 950 kg/m³, and a MIF value (MIF^{II}) lower than the MIF^{I} value of A^{I});
wherein the amounts of A^{I}) and A^{II}) are referred to the total weight of A^{I})+A^{II}); and
B) from 1% to 15% by weight of a butene-1 polymer component;
wherein the amounts of A) and B) are referred to the total weight of A)+B).

2. The polyolefin composition of claim 1, having D^{I}-D^{II}, which is the difference between the density values of A^{I}) and A^{II}) respectively, from 5 to 15 kg/m³.

3. The polyolefin composition of claim 1, having MIF^{I}-MIF^{II}, which is the difference between the MIF values of A^{I}) and A^{II}) respectively, from 5 to 20, g/10 min.

4. The polyolefin composition of claim 1, wherein the ethylene polymer component A^{I}) has a MIF/MIP value of from 5 to 15.

5. The polyolefin composition of claim 1, wherein the ethylene polymer component A^{II}) has a MIF/MIP value of from 20 to 40.

6. The polyolefin composition of claim 1, wherein the ethylene polymer component AII) has a Mw/Mn value of from 20 to 40, where Mw and Mn are the weight average molecular weight and the number average molecular weight respectively, measured by GPC.

7. The polyolefin composition of claim 1, wherein the butene-1 polymer component B) is a homopolymer or a copolymer having a comonomer content of from 0.5% to 10% by mole.

8. The polyolefin composition of claim 1, wherein the butene-1 polymer component B) has at least one of the following additional features:
a MIE value of from 0.05 to 50 g/10 min., where MIE is the Melt Flow Index MI at 190° C. with a load of 2.16 kg, determined according to ISO 1133-1:2011;
an isotacticity from 90 to 99%, measured as mmmm pentads/total pentads with 13C-NMR operating at 150.91 MHz;
a molecular weight distribution (Mw/Mn) equal to or lower than 9, where Mw and Mn are the weight average molecular weight and the number average molecular weight respectively, measured by GPC;
a melting point TmII, measured by DSC (Differential Scanning Calorimetry) in the second heating run with a scanning speed of 10° C./min., equal to or lower than 125° C.; or
an X-ray crystallinity of from 25 to 65%.

9. A filament comprising the polyethylene composition of claim 1.

10. The filament of claim 9, stretched with a stretching ratio from 1.5:1 to 10:1.

11. An article of manufacture comprising the filament of claim 9.

12. The article of manufacture of claim 11, selected from the group consisting of nets and ropes.

13. A fiber comprising the polyethylene composition of claim 1.

14. The fiber of claim 13, stretched with a stretching ratio from 1.5:1 to 10:1.
